(19) United States
(12) Patent Application Publication
(10) Pub. No.: US 2023/0128135 A1
(43) Pub. Date: Apr. 27, 2023

(54) METHYL CELLULOSE SLURRY, METHOD FOR PRODUCING THE SAME, MEAT-LIKE PROTEIN PROCESSED FOOD PRODUCT CONTAINING THE METHYL CELLULOSE SLURRY, AND METHOD FOR PRODUCING THE PROCESSED FOOD PRODUCT

(71) Applicant: NISSIN FOODS HOLDINGS CO., LTD., Osaka-shi Osaka (JP)

(72) Inventors: Tomoko NAMBU, Osaka (JP); Kazuki YOSHIDA, Osaka (JP)

(21) Appl. No.: 17/906,838

(22) PCT Filed: Sep. 9, 2021
(86) PCT No.: PCT/JP2021/033148

§ 371 Date: Sep. 20, 2022

(30) Foreign Application Priority Data
Sep. 16, 2020 (JP) 2020-155405

(51) Int. Cl. A23J 3/22; C08J 3/03; A23J 3/14

(52) U.S. Cl. CPC A23J 3/227; C08J 3/03; A23J 3/14; C08J 2301/26

(57) ABSTRACT

The invention provides a methyl cellulose slurry for a meat-like protein processed food product having higher elasticity than a conventional one and having little variation in quality and a meat-like protein processed food product using the methyl cellulose slurry. By retaining a slurry containing methyl cellulose dissolved in water in a temperature zone of 0 to 5° C. for 10 hours or more, a methyl cellulose slurry for a meat-like protein processed food product having higher elasticity than a conventional one and having little variation in quality can be provided. Moreover, by using the methyl cellulose slurry, a meat-like protein processed food product having higher elasticity than a conventional one and having little variation in quality can be provided.

### TECHNICAL FIELD

The invention relates to a methyl cellulose slurry, a method for producing the same, a meat-like protein processed food product containing the methyl cellulose slurry, and a method for producing the processed food product.

### BACKGROUND ART

In recent years, meat alternatives (meat-like protein processed food products) using vegetable protein have been studied not only for vegetarians but also from the environmental viewpoint, and a large number of meat alternatives have been placed on the market. In a method for producing these meat alternatives, vegetable protein powders such as soybeans, peas and wheat, or textured vegetable protein produced by extruding these powders with an extruder has been used, and as a binding agent for emulsion curd containing the vegetable protein powders or for the textured vegetable protein, methyl cellulose has been used (e.g., Patent Literatures 1 to 4).

However, when methyl cellulose is used as a binding agent, there are disadvantages such that desired elasticity is not obtained, variation in texture occurs, and the quality is not stable. Moreover, methyl cellulose has usage restrictions of 2 wt % or less per food product, and there are limitations on the increase in the amount used.

### CITATION LIST

### Patent Literature

Patent Literature 1

Japanese Translation of PCT International Application Publication No. 2018-533945

### Patent Literature 2

Japanese Translation of PCT International Application Publication No. 2017-509349

### Patent Literature 3

Japanese Patent Laid-Open No. 2018-29565

### Patent Literature 4

Japanese Patent Laid-Open No. 2005-21163

### SUMMARY OF INVENTION

### Technical Problem

It is an object of the invention to provide a methyl cellulose slurry for a meat-like protein processed food product having higher elasticity than a conventional one and having little variation in quality and to provide a meat-like protein processed food product using the methyl cellulose slurry.

### Solution to Problem

The inventors have earnestly studied on production of a meat-like protein processed food product using textured vegetable protein derived from vegetables, but a problem is that not only is the elasticity as a meat lump insufficient but also the texture is not stable with each production. The inventors have earnestly studied their causes, and as a result, they have thought that the methyl cellulose slurry is the cause. Then, the inventors have further earnestly studied, and as a result, they have found a methyl cellulose slurry having better elasticity than a conventional one and having stable quality and a method for producing the slurry, and they have completed the invention.

That is to say, the methyl cellulose slurry of the invention is a methyl cellulose slurry having been retained in a temperature zone of 0 to 5° C. for 10 hours or more.

The method for producing a methyl cellulose slurry according to the invention preferably comprises a slurry preparation step of preparing a slurry containing methyl cellulose dissolved in water, and a low-temperature processing step of retaining the slurry prepared in the slurry preparation step in a temperature zone of 0 to 5° C. for 10 hours or more.

In the method for producing a methyl cellulose slurry according to the invention, the low-temperature processing step is preferably a step of freezing-thawing the slurry prepared in the slurry preparation step, and the slurry is preferably frozen-thawed in such a manner that a time for passing through the temperature zone of 0 to 5° C. during the freezing-thawing of the slurry is 10 hours or more in total.

A final product temperature of the methyl cellulose slurry produced in the method for producing a methyl cellulose slurry according to the invention is preferably 10° C. or less.

In the method for producing a methyl cellulose slurry according to the invention, a methyl cellulose content of the methyl cellulose slurry is preferably 1.5 to 4 wt %.

The meat-like protein processed food product according to the invention preferably comprises textured vegetable protein and the methyl cellulose slurry according to any one of claims 1 to 5.

The method for producing a meat-like protein processed food product according to the invention preferably comprises a dough preparation step of preparing dough by mixing textured vegetable protein and the methyl cellulose slurry according to any one of claims 1 to 5, a shaping step of shaping the dough prepared in the dough preparation step, and a heating step of heating the dough shaped in the shaping step.

### Advantageous Effects of Invention

According to the invention, a methyl cellulose slurry for a meat-like protein processed food product having higher elasticity than a conventional one and having little variation in quality can be provided. Moreover, by using the methyl cellulose slurry according to the invention, a meat-like protein processed food product having higher elasticity than a conventional one and having little variation in quality can be produced.

### DESCRIPTION OF EMBODIMENTS

Hereinafter, the invention will be described in detail. However, the invention is in no way limited to the following description.

1. Slurry Preparation Step

In the method for producing a methyl cellulose slurry according to the invention, methyl cellulose is dissolved in water to prepare a slurry. As the methyl cellulose according to the invention, methyl cellulose or hydroxypropyl methyl cellulose can be used without any problem. Properties of the methyl cellulose vary depending on the viscosity and the substitution quantity of a methoxy group and a hydroxypropoxy group, but methyl cellulose having a gelation temperature of 50° C. or more and a gel remelting temperature of about 10° C. to 50° C. is used. When methyl cellulose having a higher viscosity is used, the slurry tends to become harder even if the amount added is small, and preferable is methyl cellulose having a viscosity of 2800 mm²/s or more, and particularly preferable is high-viscosity methyl cellulose having a viscosity of 77000 mm²/s or more, in terms of a viscosity of a 2 wt % aqueous solution at 20° C. Since methyl cellulose is dissolved in cold water, the temperature of water to dissolve it is preferably 10° C. or less.

The methyl cellulose slurry according to the invention is used as a binding agent for binding textured vegetable proteins to each other in a meat-like protein processed food product mainly using textured vegetable protein, and therefore, as other raw materials, an oil, flavoring, salt, sugar and the like for imparting flavor, a vegetable protein powder serving as a protein material, such as soy protein or wheat protein, and a coloring for imparting color, such as caramel coloring, can be added. To water, methyl cellulose and these raw materials are added, and they are stirred until mousse-like with a silent cutter or the like, thereby preparing a slurry.

The methyl cellulose content of the methyl cellulose slurry according to the invention is preferably 1.5 to 4 wt %. If the content is less than 1.5 wt %, binding properties of the methyl cellulose slurry are weak, and in order to bring out a texture, the amount of the methyl cellulose slurry added is increased. If the content is more than 4 wt %, the binding properties of the methyl cellulose slurry are strong, and the elasticity is extremely strengthened, but methyl cellulose has usage restrictions as a food additive, and the amount of the slurry added is decreased, so that the binding properties are deteriorated on the contrary. The content is more preferably 2 to 3.5 wt %.

2. Low-Temperature Processing Step

Subsequently, the slurry prepared in the slurry preparation step is subjected to low-temperature processing. The low-temperature processing in the invention refers to retention of the prepared slurry in a temperature zone of 0 to 5° C. for at least 10 hours or more. By retaining the slurry in a specific temperature zone of 0 to 5° C. for a long time as above, a methyl cellulose slurry having better elasticity than a conventional one can be obtained. For retaining the slurry in a temperature zone of 0 to 5° C., the slurry may be stored at an environmental temperature of 0 to 5° C. for 10 hours or more, but when the slurry is frozen-thawed, the freezing-thawing may be carried out in such a manner that passing of the slurry through the temperature zone of 0 to 5° C. takes 10 hours or more in total. The total time for the freezing and the thawing is 10 hours or more, but it is more preferable that in the freezing, the slurry be frozen by rapid freezing, and in the thawing, the slurry be thawed in such a manner that passing of the slurry through the temperature zone of 0 to 5° C. takes 10 hours or more. By doing so, a methyl cellulose slurry maintaining a constant quality can be prepared by freezing the slurry in a large amount in advance and thawing it under the specific conditions per use.

Regarding the retention time, the higher the temperature is even in the temperature zone of 0 to 5° C., the longer the retention time becomes in order to obtain the same strength, but if the retention time is too long, a workplace problem occurs, so that it is preferable to adjust the retention temperature in the zone of 0 to 5° C., the passing method, etc. so that the retention time may be preferably 70 hours or less, more preferably 46 hours or less, and still more preferably 24 hours or less.

3. Production of Meat-Like Protein Processed Food Product

### (Dough Preparation Step)

The methyl cellulose slurry prepared can be used also as emulsion curd containing a vegetable protein powder, but is particularly preferably used as a binding agent for binding textured vegetable proteins to each other, performing shape retaining, and bringing out elasticity of a meat-like protein processed food product itself, in the production of a meat-like protein processed food product using textured vegetable protein.

The textured vegetable protein according to the invention is prepared by extruding a vegetable protein powder such as soy protein (including soybean powder), pea protein or wheat protein, and if necessary, a vegetable material such as starch and an inorganic substance such as a calcium salt with a twin-screw extruder at high temperature and high pressure, and examples thereof include puffed granular protein and fibrous protein that is obtained by extruding the above materials while cooling a discharge outlet with a cooling die or the like and thereby suppressing puffing and imparting fiber direction. The puffed granular protein has a grain-like elastic texture of minced meat such as hamburger steak, or the like, and the fibrous protein has a muscle fiber-like texture such as that of steak meat. These textured vegetable proteins can be used singly or by mixing them according to the desired texture of a meat-like protein processed food product. Furthermore, they can be used after they are crushed or cut to appropriately adjust the size, length, etc.

When they are dry or in a moisture-insufficient state, they are preferably used after they are subjected once to water absorption using water or hot water to reconstitute them. If necessary, vegetable-derived flavor of the textured vegetable protein can also be reduced by a deep fry process in which the textured vegetable protein is heated while dipping it in an oil.

The textured vegetable protein having been subjected to reconstitution or deep fry process, the methyl cellulose slurry, and as other materials, materials for seasoning and ingredients are mixed to prepare dough. The mixing method is not particularly limited, and they may be mixed by a mixer or the like or may be mixed by hand, and thus, they are mixed until homogeneous.

The content of the methyl cellulose slurry in the dough is preferably 20 to 70 wt %, and if the amount of the methyl cellulose slurry is too large, the amount of the textured vegetable protein added becomes small, resulting in bad flavor. On the other hand, if the amount of the methyl cellulose slurry is too small, it becomes difficult to shape the textured vegetable protein. The content of methyl cellulose in the dough is preferably 0.8 to 1.4 wt %. If the content is less than 0.8 wt %, the elasticity is weak, and if the content is more than 1.4 wt %, the elasticity becomes too strong.

Examples of other materials include salt, nucleic acid, monosodium glutamate, soy sauce, red wine, pepper, vegetable oils, such as soybean oil and rapeseed oil, flavoring, soy protein powder, and ingredients, such as onion, carrot and cabbage.

(Shaping Step)

The prepared dough is shaped by a shaping mold or the like. The shaping mold is not particularly limited as long as it has heat resistance, and examples thereof include those made of stainless steel, and a casing or intestine used for ham or sausage. The prepared dough is placed in such a shaping mold to shape the dough into a desired shape.

(Heating Step)

The shaped dough is heated to prepare a meat-like protein processed food product. The heating method is not particularly limited, and heating is carried out by boiling, steaming, baking, or the like. The heating method is not limited to one method, and after steaming, baking may be carried out, or after steaming, boiling cooking for seasoning may be carried out. Since the solidifying temperature of the methyl cellulose is 50° C. or more, heating is carried out in such a manner that the product temperature (central temperature) becomes about 50° C. or more, but sterilization is also included, heating is preferably carried out until the product temperature becomes 80° C. or more.

The meat-like protein processed food product prepared may be eaten if it can be eaten as it is, but it may be stored under refrigeration or freezing and then re-heated by baking, boiling or microwave cooking before it is eaten.

As described above, by subjecting the slurry containing methyl cellulose dissolved in water to low-temperature processing, a methyl cellulose slurry for a meat-like protein processed food product having higher elasticity than a conventional one and having little variation in quality can be provided. Moreover, by using the methyl cellulose slurry according to the invention, a meat-like protein processed food product having higher elasticity than a conventional one and having little variation in quality can be provided.

Hereinafter, the present embodiment will be described in more detail with reference to examples.

### EXAMPLES

<Experiment 1> Study of Low-Temperature Processing Conditions for Methyl Cellulose Slurry

The materials described in Table 1 below were stirred and mixed with a silent cutter for 5 minutes, thereby preparing a slurry.

TABLE 1

| | Blending |
|---|---|
| Material | (wt %) |
| Methyl cellulose | 3.0 |
| (Shin-Etsu Chemical Co., | |
| Ltd.: MCE-100TS) | |
| Rapeseed oil | 16.5 |
| Water | 78.5 |
| Salt | 1.0 |
| Granulated sugar | 1.0 |
| Total | 100.0 |

The slurry prepared was subjected to low-temperature processing of Test Examples 1 to 17 described in Table 3, and the total time in which the product temperature of the slurry of each experimental plot stayed in the temperature zone of 0 to 5° C. was measured by a data logger (manufactured by KN Laboratories, Inc., temperature data logger Thermochron G type). Regarding the low-temperature processing conditions in each experimental plot, Test Example 1 was carried out without low-temperature processing, Test Examples 2 and 3 were each carried out in a low-temperature storge at 10° C., Test Examples 4 to 8 were each carried out in a low-temperature storge at 5° C., and Test Examples 9 to 12 were each carried out in a low-temperature storge at 0° C. In Test Example 13, slow freezing was carried out in a commercial freezer at −20° C. while covering the slurry with a cardboard so that cold air should not be directly applied to the slurry, and thawing was carried out at 20° C., in Test Examples 14 and 15, ordinary freezing was carried out in a commercial freezer at −20° C., in Test Example 14, thawing was carried out at 20° C., and in Test Example 15, thawing was carried out at 5° C. In Test Examples 16 and 17, rapid freezing was carried out in a rapid freezer at −40° C., and thawing was carried out at 5° C., and in Test Example 17, after the slurry was thawed at 5° C., it was allowed to stand at ordinary temperature to set the product temperature to 10° C.

Regarding the methyl cellulose slurry prepared, a breaking strength of the slurry itself was measured. In the measuring method, the breaking strength was measured by a rheometer (YAMADEN co., ltd. RHEONER II CREEP METER RE2-330005C). A cylindrical plunger with a diameter of 5 mm (made of plastic) was used, and 10 g of the slurry of each experimental plot was added to a tray of 38×38×12 mm, and measurement was carried out by moving the plunger from top to bottom at a rate of 60 mm/min and thereby pressing the slurry.

Furthermore, using the prepared methyl cellulose slurry of each experimental plot, a meat-like protein processed food product (hamburger patty) was prepared, and evaluation of the elasticity of the patty was carried out.

As described in Table 2 below, in the method for preparing the patty, a substance obtained by reconstituting 12 wt % of fibrous protein having been cut into 5×5×3 mm and 10 wt % of granular protein with 0.3 wt % of caramel coloring and 9.7 wt % of water, a powder obtained by mixing 0.3 wt % of monosodium glutamate, 0.2 wt % of nucleic acid, 5 wt % of a soy protein isolate powder, 0.4 wt % of black pepper and 0.2 wt % of powdery tocopherol, a liquid obtained by mixing 4.2 wt % of soy sauce, 1.5 wt % of glycerol and 2.7 wt % of concentrated red wine, a fat or oil mixture containing 3 wt % of soybean oil, 0.1 wt % of rapeseed oil and 4 wt % of shortening and having been dissolved by heating, 6 wt/o of sauteed onion having been cut into 3 mm square, and 40 wt % of the methyl cellulose slurry prepared in each of Test Examples 1 to 17 were mixed to prepare dough (100 wt %). The dough was sufficiently stirred, and an ellipse mold of 126×96×15 mm was filled with the dough in such a manner that the amount of the dough per mold became 150 g, thereby shaping the dough. Thereafter, the dough was subjected to heating process at 98° C. for 15 minutes (central temperature was 80° C. or more) with a steamer, then cooled, and frozen by a rapid freezer at −30° C., thereby preparing a meat-like protein processed food product sample.

TABLE 2

| | | Proportion |
|---|---|---|
| Material | | (wt %) |
| Fibrous | Fibrous protein | 12.5 |
| protein | | |
| Granular | Granular protein | 10.0 |
| protein | Water | 9.7 |
| | Caramel coloring | 0.3 |
| Powder | Monosodium glutamate | 0.3 |
| | Nucleic acid | 0.2 |
| | Soy protein isolate powder | 5.0 |
| | Black pepper | 0.4 |
| | Tocopherol | 0.2 |
| Liquid | Dark soy sauce | 4.2 |
| | Glycerol | 1.5 |
| | Concentrated red wine | 2.7 |
| Fat or oil | Soybean oil | 3.0 |
| mixture | Rapeseed oil | 0.1 |
| | Shortening | 4.0 |
| Ingredient | Sauteed onion (dice) | 6.0 |
| Slurry | Methyl cellulose slurry | 40.0 |

| | |
|---|---|
| Total | 100.0 |

The frozen sample of each experimental plot was baked for 2 minutes each side on a frying pan having been heated to 180′C and then further baked for 1 minute each side thereon, and the resulting sample was eaten and subjected to sensory evaluation. The sensory evaluation was carried out on a 5-point scale, and a sample having very good elasticity was evaluated as 5, a sample having good elasticity was evaluated as 4, a sample having elasticity and acceptable as a commercial product was evaluated as 3, a sample having weak elasticity and inacceptable as a commercial product was evaluated as 2, and a sample having extremely weak elasticity and inacceptable was evaluated as 1.

Low-temperature processing conditions of each experimental plot, retention time in the temperature zone of 0 to 5° C., results of analysis by a rheometer, and results of sensory evaluation of a meat-like protein processed food product are set forth in Table 3 below.

TABLE 3

| | Cooling | | | | 0-5° C. | 0-5° C. | 0-5° C. | Slurry product | | |
|---|---|---|---|---|---|---|---|---|---|---|
| Experi- | freezing | Cooling | Thawing | | Retention | Retention time | Retention time | temperature | Slurry | Sensory |
| mental | temperature | freezing | temperature | Thawing | time | during freezing | during thawing | during use | breaking | evaluation |
| plot | (° C.) | time (H) | (° C.) | time (H) | (H) | (H) | (H) | (° C.) | strength (N) | of patty |
| 1 | — | — | — | — | — | — | — | 18° C. | 7.09 | 1 |
| 2 | 10 | 1 | — | — | 0 | — | — | 10 | 7.52 | 1 |
| 3 | 10 | 24 | — | — | 0 | — | — | 10 | 8.75 | 2 |
| 4 | 5 | 1 | — | — | 0 (0.1) | — | — | 5 | 8.29 | 2 |
| 5 | 5 | 12 | — | — | 11 | — | — | 5 | 9.87 | 3 |
| 6 | 5 | 24 | — | — | 22 | — | — | 5 | 10.13 | 3 |
| 7 | 5 | 48 | | | 46 | — | | 5 | 12.87 | 5 |
| 8 | 5 | 72 | — | — | 70 | — | — | 5 | 13.35 | 4 |
| 9 | 0 | 1 | — | — | 0 (0.2) | — | — | 0 | 9.2 | 2 |
| 10 | 0 | 12 | — | — | 11 | — | — | 0 | 11.18 | 4 |
| 11 | 0 | 18 | — | — | 17 | — | — | 0 | 12.5 | 5 |
| 12 | 0 | 24 | — | — | 23 | — | — | 0 | 13.6 | 4 |
| 13 | −20° C. | 24 | 20 | 5 | 10 | 6 | 4 | 5 | 10.29 | 3 |
| | (Slow) | | | | | | | | | |
| 14 | −20° C. | 5 | 20 | 5 | 5 | 1 | 4 | 5 | 8.99 | 2 |
| 15 | −20° C. | 5 | 5 | 24 | 24 | 1 | 23 | 5 | 12.35 | 5 |
| 16 | −40° C. | 1 | 5 | 24 | 23 | 0 (0.2) | 23 | 5 | 11.27 | 5 |
| 17 | −40° C. | 1 | 5 | 24 | 23 | 0 (0.2) | 23 | 10 | 9.81 | 3 |

As shown in Test Examples 1, 2, 4 and 9, by decreasing the cooing temperature, the breaking strength of the methyl cellulose slurry increases, but in the case of a short time, the breaking strength of the methyl cellulose slurry does not increase to such a high degree that a patty exhibits a texture of sufficient elasticity, and in the conventional method in which a methyl cellulose slurry is prepared during the preparation of a patty, a sufficient breaking strength is not obtained no matter how decreased the temperature is. Moreover, in the conventional method in which a methyl cellulose slurry is prepared during the preparation of a patty, the breaking strength varies depending on the product temperature of the methyl cellulose slurry, and therefore, variation in quality of a patty tends to be brought about.

As shown in Test Example 3, by retaining the methyl cellulose slurry at a temperature higher than 5° C. for a long time, the methyl cellulose slurry strength increases, but the breaking strength of the methyl cellulose slurry does not increase to such a high degree that a patty exhibits a texture of sufficient elasticity.

In contrast therewith, as shown in Test Examples 5 to 8 and Test Examples 10 to 12, by retaining the methyl cellulose slurry in a temperature zone of 0 to 5° C. for 10 hours or more, the breaking strength of the methyl cellulose slurry can be made higher than that in the conventional method in which a methyl cellulose slurry is prepared during the preparation of a patty, and also in the evaluation of a patty, high enough sensory evaluation is obtained. As shown in Test Examples 5 to 8 and Test Examples 10 to 12, as the product temperature decreases even in the temperature zone of 0 to 5° C., the breaking strength of the methyl cellulose slurry increases in a short time, and as the retention time in the temperature zone of 0 to 5° C. becomes longer, the breaking strength of the methyl cellulose slurry increases. However, as shown in Test Example 8 and Test Example 12, if the breaking strength of the slurry becomes too strong, the elasticity of the patty in the sensory evaluation also becomes too strong, and therefore, it is preferable to adjust the retention time in the zone of 0 to 5° C. so that an appropriate methyl cellulose slurry strength may be obtained.

As shown in Test Example 14, when the total time for passing through the zone of 0 to 5° C. during the freezing-thawing is less than 10 hours, a sufficient breaking strength of the methyl cellulose slurry is not obtained, but as shown in Test Examples 13 to 17, by freezing-thawing the slurry prepared, then passing it through the temperature zone of 0 to 5° C. and thereby retaining it in the temperature zone of 0 to 5° C. for 10 hours or more, the breaking strength of the methyl cellulose slurry can be made higher than that in the conventional method in which a methyl cellulose slurry is prepared during the preparation of a patty, and also in the evaluation of a patty, high enough sensory evaluation is obtained.

As shown in Test Example 13, by lengthening the retention time in the zone of 0 to 5° C. during freezing and thereby allowing the retention time in the zone of 0 to 5° C. to be 10 hours or more, the breaking strength of the methyl cellulose slurry can also be increased, and as shown in Test Example 15 and Test Example 16, by carrying out freezing rapidly and then carrying out thawing slowly to lengthen the time for passing through the zone of 0 to 5° C. and to thereby allow the retention time in the zone of 0 to 5° C. to be 10 hours or more, the breaking strength of the slurry can also be increased. The method based on freezing-thawing can prepare a larger amount of a slurry and can store it, and by thawing the slurry under certain conditions before use, the breaking strength of the methyl cellulose slurry is stabilized, and as a result, it becomes possible to produce a patty having stable quality. Taking a long time for passing through the temperature zone of 0 to 5° C. for thawing is more desirable than taking a long time for passing through the temperature zone of 0 to 5° C. for freezing because the work is simple and easy.

In Test Example 17, the methyl cellulose slurry having been subjected to low-temperature processing once was allowed to stand to elevate the product temperature up to 10° C., but when the temperature was elevated up to 10° C., the strength of the methyl cellulose slurry decreases, and therefore, the product temperature of the methyl cellulose slurry during use is preferably 10° C. or less, and more preferably 5° C. or less.

<Experiment 2> Study on Hamburger Patty

Slurries were prepared in the same manner as in Experiment 1 with the blending shown in Table 4 below, and thereafter, they were subjected to the same low-temperature processing at −40° C. as in Test Example 16, thereby preparing methyl cellulose slurries (Test Examples 18 to 23).

TABLE 4

| | Test Example | | | | |
|---|---|---|---|---|---|
| | 18, 23 | 19 | 20 | 21 | 22, 24 |
| | Blending | Blending | Blending | Blending | Blending |
| Material | (wt %) | (wt %) | (wt %) | (wt %) | (wt %) |
| Methylcellulose | 1.5 | 2.0 | 3.0 | 3.5 | 4.0 |
| (Shin-Etsu | | | | | |
| Chemical | | | | | |
| Co., Ltd.: | | | | | |
| MCE-100TS) | | | | | |
| Rapeseed oil | 16.5 | 16.5 | 16.5 | 16.5 | 16.5 |
| Water | 80.0 | 79.5 | 78.5 | 78.0 | 77.5 |
| Salt | 1.0 | 1.0 | 1.0 | 1.0 | 1.0 |
| Granulated | 1.0 | 1.0 | 1.0 | 1.0 | 1.0 |
| sugar | | | | | |
| Total | 100.0 | 100.0 | 100.0 | 100.0 | 100.0 |

Using the methyl cellulose slurries prepared, meat-like protein processed food products (hamburger patties) were prepared in the same manner as in Experiment 1 with the blending shown in Table 5 below in Experiment 1, and they were cooked in the same manner as in Experiment 1 and subjected to sensory evaluation. Further, shape retention of each test example was also evaluated. Regarding the shape retention of a patty, a sample obtained by subjecting the patty to heating process and cooling was evaluated. A sample that exhibits firm shape retention and is very good is evaluated as 5, a sample that exhibits a little poor shape retention but is good is evaluated as 4, a sample that exhibits slightly poor shape retention but is almost acceptable without collapsing is evaluated as 3, a sample that exhibits poor shape retention and collapses is evaluated as 2, and a sample that does not exhibit shape retention is evaluated as 1. The evaluation results are set forth in Table 6 below.

TABLE 5

| | | Test Example | | |
|---|---|---|---|---|
| | | 18-22 | 23 | 24 |
| | | Pro- | Pro- | Pro- |
| | | portion | portion | portion |
| Material | | (wt %) | (wt %) | (wt %) |
| Fibrous protein | Fibrous protein | 12.5 | 9.4 | 16.7 |
| Granular protein | Granular protein | 10.0 | 7.5 | 13.3 |
| | Water | 9.7 | 0.6 | 12.9 |
| | Caramel coloring | 0.3 | 0.3 | 0.4 |
| Powder | Monosodium glutamate | 0.3 | 0.2 | 0.4 |
| | Nucleic acid | 0.2 | 0.1 | 0.2 |
| | Soy protein isolate powder | 5.0 | 2.5 | 6.7 |
| | Black pepper | 0.4 | 0.2 | 0.5 |
| | Tocopherol | 0.2 | 0.1 | 0.3 |
| Liquid | Dark soy sauce | 4.2 | 1.4 | 5.6 |
| | Glycerol | 1.5 | 0.5 | 2.0 |
| | Concentrated red wine | 2.7 | 0.9 | 3.6 |
| Fat or oil mixture | Soybean oil | 3.0 | 1.0 | 4.0 |
| | Rapeseed oil | 0.1 | 0.0 | 0.1 |
| | Shortening | 4.0 | 1.3 | 5.3 |
| Ingredient | Sauteed onion (dice) | 6.0 | 4.0 | 8.0 |
| Slurry | Methyl cellulose slurry | 40.0 | 70.0 | 20.0 |

| | | | |
|---|---|---|---|
| Total | 100.0 | 100.0 | 100.0 |

TABLE 6

| | | Amount l | | | |
|---|---|---|---|---|---|
| | Methyl | of methy | Methyl | | |
| | cellulose | cellulose | cellulose | | |
| | concentration | slurry | concentration | | |
| | in methyl | blended | in | | |
| Test | cellulose | in patty | patty | Shape | Sensory |
| Example | slurry (wt %) | (wt %) | (wt %) | retention | evaluation |
| 18 | 1.5 | 40 | 0.6 | 3 | 2 |
| 19 | 2.0 | 40 | 0.8 | 4 | 3 |
| 20 | 3.0 | 40 | 1.2 | 5 | 5 |
| 21 | 3.5 | 40 | 1.4 | 5 | 4 |
| 22 | 4.0 | 40 | 1.6 | 5 | 2 |
| 23 | 1.5 | 70 | 1.1 | 4 | 4 |
| 24 | 4.0 | 20 | 0.8 | 4 | 3 |

As shown in Test Examples 18 to 22, as the methyl cellulose concentration in the methyl cellulose slurry increases, the shape retention of the patty becomes better. On the other hand, in the sensory evaluation, as the methyl cellulose concentration in the slurry increases, the methyl cellulose concentration in the patty also increases, and the elasticity as a texture becomes stronger, but when the methyl cellulose concentration in the patty becomes too high, the elasticity becomes too strong, resulting in low evaluation.

As shown in Test Examples 23 and 24, when the methyl cellulose concentration in the methyl cellulose slurry is low or high, increase or decrease of the amount of the methyl cellulose slurry blended in the patty makes it possible to improve shape retention and a texture.

From the results of Experiment 2, the concentration of methyl cellulose in the methyl cellulose slurry is preferably 1.5 to 4 wt %, and more preferably 2 to 3.5 wt %. The concentration of methyl cellulose in the patty is preferably 0.8 to 1.4 wt %, and more preferably 1.1 to 1.4 wt %. The amount of the methyl cellulose slurry blended in the patty is preferably 20 to 70 wt %.

1. A methyl cellulose slurry having been retained in a temperature zone of 0 to 5° C. for 10 hours or more.

2. A method for producing a methyl cellulose slurry, comprising
a slurry preparation step of preparing a slurry containing methyl cellulose dissolved in water, and
a low-temperature processing step of retaining the slurry prepared in the slurry preparation step in a temperature zone of 0 to 5° C. for 10 hours or more.

3. The method for producing a methyl cellulose slurry according to claim 2, wherein the low-temperature processing step is a step of freezing-thawing the slurry prepared in the slurry preparation step, and wherein the slurry is frozen-thawed in such a manner that a time for passing through the temperature zone of 0 to 5° C. during the freezing-thawing of the slurry is 10 hours or more in total.

4. The method for producing a methyl cellulose slurry according to claim 2, wherein a final product temperature of the methyl cellulose slurry is 10° C. or less.

5. The method for producing a methyl cellulose slurry according to claim 2, wherein a methyl cellulose content of the methyl cellulose slurry is 1.5 to 4 wt %.

6. A meat-like protein processed food product comprising textured vegetable protein and the methyl cellulose slurry according to claim 1.

7. A method for producing a meat-like protein processed food product, comprising
a dough preparation step of preparing dough by mixing textured vegetable protein and the methyl cellulose slurry according to claim 1,
a shaping step of shaping the dough prepared in the dough preparation step, and
a heating step of heating the dough shaped in the shaping step.

8. The method for producing a methyl cellulose slurry according to claim 3, wherein a final product temperature of the methyl cellulose slurry is 10° C. or less.

9. The method for producing a methyl cellulose slurry according to claim 3, wherein a methyl cellulose content of the methyl cellulose slurry is 1.5 to 4 wt %.

10. The method for producing a methyl cellulose slurry according to claim 4, wherein a methyl cellulose content of the methyl cellulose slurry is 1.5 to 4 wt %.

11. The method for producing a methyl cellulose slurry according to claim 8, wherein a methyl cellulose content of the methyl cellulose slurry is 1.5 to 4 wt %.

12. A meat-like protein processed food product comprising textured vegetable protein and the methyl cellulose slurry according to claim 2.

13. A meat-like protein processed food product comprising textured vegetable protein and the methyl cellulose slurry according to claim 3.

14. A meat-like protein processed food product comprising textured vegetable protein and the methyl cellulose slurry according to claim 4.

15. A meat-like protein processed food product comprising textured vegetable protein and the methyl cellulose slurry according to claim 5.

16. A method for producing a meat-like protein processed food product, comprising
a dough preparation step of preparing dough by mixing textured vegetable protein and the methyl cellulose slurry according to claim 2,
a shaping step of shaping the dough prepared in the dough preparation step, and
a heating step of heating the dough shaped in the shaping step.

17. A method for producing a meat-like protein processed food product, comprising
a dough preparation step of preparing dough by mixing textured vegetable protein and the methyl cellulose slurry according to claim 3,
a shaping step of shaping the dough prepared in the dough preparation step, and
a heating step of heating the dough shaped in the shaping step.

18. A method for producing a meat-like protein processed food product, comprising
a dough preparation step of preparing dough by mixing textured vegetable protein and the methyl cellulose slurry according to claim 4,
a shaping step of shaping the dough prepared in the dough preparation step, and
a heating step of heating the dough shaped in the shaping step.

19. A method for producing a meat-like protein processed food product, comprising
a dough preparation step of preparing dough by mixing textured vegetable protein and the methyl cellulose slurry according to claim 5,
a shaping step of shaping the dough prepared in the dough preparation step, and
a heating step of heating the dough shaped in the shaping step.
